(19) United States
(12) Patent Application Publication
(10) Pub. No.: US 2006/0019865 A1
(43) Pub. Date: Jan. 26, 2006

(54) Methods and compositions of multifunctional detergent components

(76) Inventor: Enrique Hernandez, Brownsville, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/894,957

(22) Filed: Jul. 20, 2004

(51) Int. Cl. C11D 3/02

(52) U.S. Cl. 510/511

(57) ABSTRACT

A compound for use in a detergent composition is provided that has formula X(SiO₂).(Na₂O).Z(H₂O), wherein X is about 0.5 to about 1.2, and Z is greater than about 0.1. Methods and systems for making the compound are also provided.

### TECHNICAL FIELD OF THE INVENTION

The present invention relates generally to multifunctional detergent components and more particularly to metasilicate compositions and methods of efficiently making and using metasilicate compositions.

### BACKGROUND OF THE INVENTION

Detergents used for laundry and general purpose cleaners typically include numerous components. Each component of the detergent may perform one or more functions in the manufacture or use of the detergent. Components may serve as cleaning agents, pH control agents, corrosion protectors, builders, conditioners, alkaline agents, fillers, carriers, or perfumes. Since each component of the detergent has its individual cost to produce, transport and store, it is often times desirable to have one component perform many functions. Therefore, a multifunctional detergent component may reduce the cost of the entire detergent.

An important component of detergents and cleaners are builders. Builders may soften the water as well as enhance the detergent effect. Builders soften the water by capturing the calcium or magnesium cations within the water. By softening the water, the builders also enhance the effect of the surface-active material (surfactants) used as cleaning agents. A detergent product typically contains surfactants which are used to lift dirt from the fabrics and to penetrate into the fabrics to remove embedded soil. The calcium or magnesium cations within the water cause the surfactant to be inactivated due to the formation of insoluble salts. Builders help to remove these cations that inactivate the surfactant.

Builders that are typically used include phosphate salts and zeolites. Phosphate salts such as sodium tripolyphosphate or sodium pyrophosphate have been extensively used. Zeolites also serve as builders in detergent products. Zeolites are porous alumino-silicate minerals that may be either a natural or manmade material. Manmade zeolites are based on the same type of structure as natural zeolites. Zeolites are composed of a three-dimensional framework of SiO₄ and AlO₄ in a tetrahedron, which creates very high surface area. Zeolites act by entraining metal cations and water molecules into their framework. Zeolites are widely used in detergents and represent 80-90% of the world market.

However, both phosphates and zeolites builders have disadvantages. First, due to environmental concerns, major markets including the United States, Japan, and the European Union have banned the use of phosphorous-containing compounds in detergent products. Zeolites also have their own particular disadvantages. Zeolites typically do not work as well as phosphates; for example, zeolites have a weaker magnesium binding capacity. Zeolites also have solubility problems, limiting their use in liquid products. Zeolites are disadvantageous in that, as an insoluble material, they may be retained upon clothing or fabric and may cause excessive wear of washing machine components. Zeolites may also be comparatively expensive, increasing the cost of the final detergent product.

### SUMMARY OF THE INVENTION

The present invention is directed, according to one embodiment, to a method of making a metasilicate compound, the method including mixing a sodium source, a silica source and sodium silicate to form a mixture with a substantially uniform SiO₂:Na₂O ratio throughout and heating the mixture to first and second temperatures to form the metasilicate compound.

According to another embodiment of the present invention, a method of making a metasilicate compound is disclosed, the method including combining a silica source and a sodium source and treating the silica source and the sodium source with steam to form a liquid metasilicate compound.

In another embodiment of the present invention, a system for making metasilicate compound is disclosed, the system including a mixer to mix a sodium source, a silica source and sodium silicate into a mixture with a substantially uniform SiO₂:Na₂O ratio throughout and a heater to heat the mixture to a first temperature of about 400° C. to about 700° C. In a further embodiment, the system includes a second heater to heat the mixture to a second temperature. In some embodiments, the second temperature is about 700° C. to about 900° C. and the silica source has a silica fine size of 100 mesh or greater. In other embodiments, the second temperature is about 950° C. to about 1500° C. and the silica source has a silica fine size of less than about 100 mesh. In one embodiment, the system further includes at least one duct to direct at least a portion of heat from the second heater to the first heater.

In another embodiment of the present invention, a system for making liquid metasilicate is disclosed, the system includes a tank to receive and steam agitate a sodium source and a silica source to form a liquid mixture having a substantially uniform SiO₂:Na₂O ratio throughout.

The present invention is also directed, according to one embodiment, to a compound for use in a detergent composition, the compound having the formula: X(SiO₂).(Na₂O).Z(H₂O), wherein X is about 0.5 to about 1.2, and Z is greater than about 0.1.

According to one embodiment, the present invention teaches a detergent composition comprising a cleaning agent and an effective amount of builder, the builder having the formula: X(SiO₂).(Na₂O).Z(H₂O), wherein X is about 0.5 to about 1.2, and Z is greater than about 0.1.

According to another embodiment, the present invention teaches a detergent composition comprising a cleaning agent and an effective amount of neutralizing agent, the neutralizing agent having the formula: X(SiO₂).(Na₂O).Z(H₂O), wherein X is about 0.5 to about 1.2, and Z is greater than about 0.1.

In one embodiment of the present invention, a detergent composition includes, by weight, about 1% to about 45% cleaning agent, and about 3% to about 95% a metasilicate compound having the formula: X(SiO₂).(Na₂O).Z(H₂O), where X is about 0.5 to about 1.2, and wherein Z is greater than about 0.1.

In another embodiment of the present invention, a detergent composition includes, by weight, about 13% to about 15% a cleaning agent; about 25% to about 30% a metasilicate compound having the formula: X(SiO₂).(Na₂O).Z(H₂O), wherein X is about 0.5 to about 1.2, and where Z is greater than about 0.1; about 45% to about 50% a filler; and about 10% at least one additive.

In one embodiment of the present invention, a detergent composition includes, by weight, about 15% to about 17% a cleaning agent; about 30% to about 40% a metasilicate compound having the formula: X(SiO₂).(Na₂O).Z(H₂O), wherein X is about 0.5 to about 1.2, and where Z is greater than about 0.1; about 45% to about 50% a filler; and about 3% to about 6% at least one additive.

### BRIEF DESCRIPTION OF THE DRAWINGS

A more complete understanding of embodiments of the present invention and advantages thereof may be acquired by referring to the following description taken in conjunction with the accompanying drawings, in which like reference numbers indicate like features, and wherein:

FIG. 1 illustrates a system for making metasilicate according to an embodiment of the present invention;

FIG. 2 illustrates another system for making metasilicate according to an embodiment of the present invention;

FIG. 3 illustrates a flow chart for a method of making metasilicate according to an embodiment of the present invention; and

FIG. 4 illustrates a flow chart for another method of making metasilicate according to an embodiment of the present invention.

### DETAILED DESCRIPTION OF THE PREFERRED EMBODIMENTS

An embodiment of the present invention relates to a metasilicate compound having the formula of X(SiO₂).(Na₂O).Z(H₂O). Wherein X may be about 0.5 to about 1.2. Having a silica to sodium ratio in this range may allow for the enhanced solubility of the metasilicate. In this range the metasilicate may not have glassy characteristics. Also, the metasilicate may have a favorable alkalinity in this range. Below this range the metasilicate may be too alkaline for use in some detergent applications. In some embodiments of the present invention, X may be about 0.7 to about 1.2. In other embodiments, X may preferably be about 0.9 to about 1.1. In further embodiments, X may be about 0.7 to about 0.9.

In embodiments of the present invention, the value of Z in the formula, X(SiO₂).(Na₂O).Z(H₂O), may comprise greater than about 0.1. In embodiments where Z nears 0, the metasilicate may be relatively anhydrous. In embodiments where Z ranges from 0.1 to 9, the metasilicate is typically in a solid, crystallized form. Metasilicate having a low value of Z may be preferred in concentrated detergents that desire less bulk. Metasilicate having a low value of Z may also reduce storage, transportation and other costs associated with making detergents.

In other embodiments of the present invention, Z may preferably be 5. This may be referred to as metasilicate penta hydrate. Metasilicate penta hydrate is typically a solid form of metasilicate that has approximately five water molecules coordinated around each metasilicate crystal. It has been discovered that metasilicate penta hydrate may be advantageous when additional bulk is required for a detergent. It has further been discovered that the additional water adds bulk and weight to a detergent for a comparatively low cost. Roughly 42.5% of metasilicate penta hydrate's weight comprises water. Therefore, metasilicate penta hydrate may reduce the amount of filler (such as sodium sulfate) required for a particular detergent. Using water as filler, also may have environmental advantages over using sulfates.

In other embodiments of the present invention, the value of Z may range from 0.1 to 9. Here, one may vary the amount of water present in the metasilicate to have a desired property. For example, one may adjust the amount of water in the metasilicate to have a desired bulk. In some embodiments of the present invention, such as when the value of Z approaches the value of 10 or higher, the metasilicate may be present in a liquid form. It has been discovered that a liquid metasilicate may be desirable in detergent manufacturing processes, such as spray drying and making a liquid detergent.

In several embodiments of the present invention, the metasilicates may be used in different manufacturing processes as well as different detergent presentations. The manufacturing processes include tower, agglomerator, and liquid manufacturing processes. The metasilicates of the present invention may also be included in various forms of detergents and cleaning products. These products may include detergents and cleaning agents as well as concentrates in either solid, gel or liquid form.

It has been discovered that embodiments of the present invention allow the metasilicate to perform one or more roles in the detergent. The metasilicate may be suitable to serve as a builder in the detergent composition. As a builder, the metasilicate may soften the water by removing metal cations. When added as a builder, the metasilicate may replace traditional phosphate and zeolite builders. Embodiments of this invention also include combinations of metasilicates and traditional builders. An effective amount of builders in a detergent composition typically is composed of about 25% to about 30% of the detergent composition by weight.

In another embodiment, the metasilicate may serve as a neutralizing agent in the final detergent composition. As an alkaline material, the metasilicate may act to neutralize the surfactant. By serving as a neutralizing agent, the metasilicate may reduce the amount of other alkaline material needed in the detergent composition. For example, the amount of soda ash used as a neutralizing agent in a detergent may be reduced. An effective amount of neutralizing agent in a typical detergent composition composes about 1% to about 5% of the detergent composition by weight.

In another embodiment, the metasilicate of the present invention may serve as a filler. Conventional detergents may comprise, by weight, about 45% to about 50% filler material such as sodium sulfate. Hydrated forms of metasilicate, such as metasilicate penta hydrate, may allow for a more cost efficient filler material.

Other embodiments allow the metasilicate to serve, among other functions, as a pH control agent, a corrosion protector, a conditioner, and/or an alkaline agent, and/or more than one of the discussed functions.

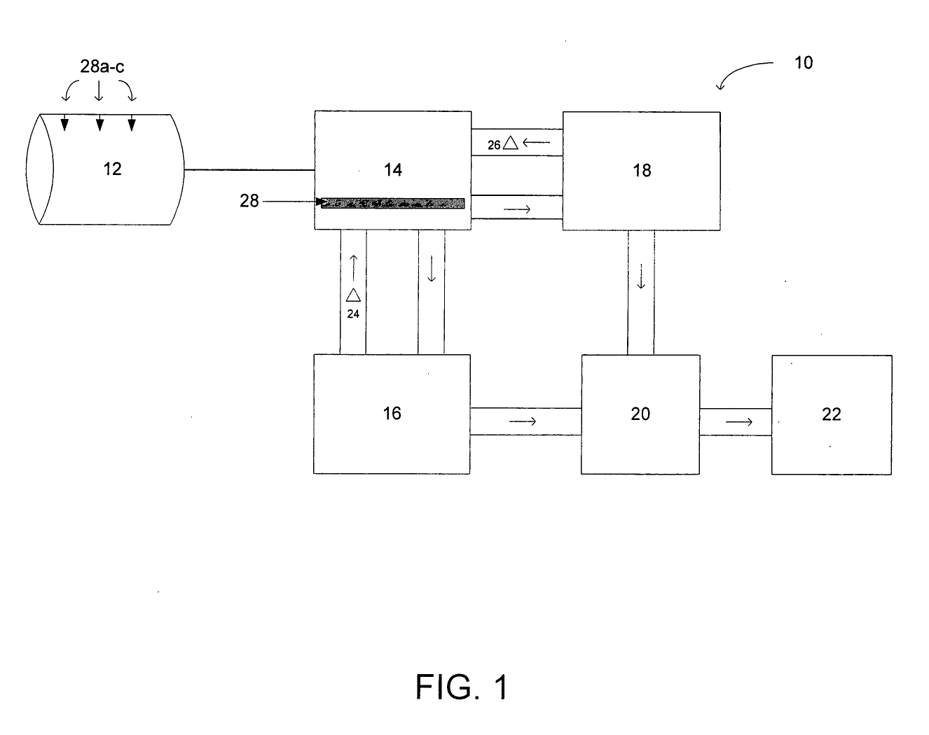

FIG. 1 illustrates system 10 for making metasilicate according to an embodiment of the present invention. System 10 includes mixer 12. Mixer 12 may be operable to receive, mix and agglomerate a sodium source, a silica source, and sodium silicate. Mixer 12 may be a finger, ribbon, or some other mixer suitable for the purpose.

Mixer 12 mixes the sodium source, silicon source, and sodium silicate so as to form a mixture with a substantially uniform SiO₂:Na₂O ratio throughout. A substantially uniform SiO₂:Na₂O ratio throughout means a mixture that has a roughly even dispersion of the individual ingredients all the way through the mixture. Having a substantially uniform SiO₂:Na₂O ratio throughout may allow suitable contact area between the sodium source, silicon source, and sodium silicate so as to react to form a metasilicate compound. In certain exemplary embodiments, the SiO₂:Na₂O ratio has a ratio of about 0.5 to about 1.2 SiO₂ to about 1 Na₂O.

In some embodiments of the present invention, the sodium source may be soda ash (Na₂CO₃) and/or caustic soda (NaOH) and/or a mixture of more than one soda source. In another embodiment, the silicon source comprises silicon dioxide (SiO₂). In other embodiments, the sodium silicate may be in a liquid or dry form. As a liquid sodium silicate form, mixer 12 may be able to spray the sodium silicate into the mixture using nozzles 28a-c.

The silica source may comprise a fine size ranging from about 40 mesh to about 180 mesh. A larger mesh number will indicate a smaller fine size. Therefore, a silica particle with a fine size of 120 mesh will be smaller (finer) than a silica particle with a fine size of 100 mesh. And a silica particle with a fine size of 80 mesh will be larger (courser) than a silica particle with a fine size of 100 mesh.

Associated with mixer 12 is heater 14. Heater 14 receives the mixture from mixer 12 and heats the mixture to a first temperature. In embodiments of the present invention, the first temperature has a range of about 400 degrees Celsius (° C.) to about 900° C. Heating the mixture may encourage the decomposition of the sodium source and silicon source to form reactive species. In certain embodiments, heater 14 may provide enough heat to react the mixture to form metasilicate. Heater 14 may serve additional functions in the reaction. For example, by heating the mixture to a first temperature, which may be lower than a second temperature, the reaction mixture may be heated at a slower, more even, pace. This may prevent the silicon source of the mixture from vitrifying upon exposure to a high temperature source.

Heater 16 may be associated with heater 14. Heater 16 is operable to receive the mixture from heater 14. Heater 16 heats the mixture to a second temperature. In embodiments of the present invention, the second temperature is in the range of about 700° C. to about 900° C. Heater 16, it is believed, serves to more fully activate and react the mixture to form a metasilicate compound. In certain exemplary embodiments, heater 16 and heater 14 may be the same heating device. In other exemplary embodiments, heater 16 may be a rotary kiln, calcinator, an oven, a furnace or the like.

Associated with heater 14 may be heater 18. Heater 18 is operable to receive the mixture from heater 14. Heater 18 heats the mixture to another second temperature. In certain exemplary embodiments, the second temperature is in the range of about 950° C. to about 1500° C. Heater 18, it is believed, serves to more fully activate and react the mixture so to form a metasilicate compound. In certain exemplary embodiments, heater 18 and heater 14 may be the same heating device. In further embodiments, heater 18 may be the same heating device as heater 16. In other exemplary embodiments, heater 18 may be a rotary kiln, smelter, an oven, a furnace, or the like.

In embodiments of the present invention, system 10 may have both heater 16 and heater 18, or system 10 may only have heater 16 or heater 18. Many factors may determine if the manufacturer uses heater 16 or heater 18. One factor may be energy costs of using heater 16 versus heater 18. Another factor may include the fine size of the silica source. Typically, if the silica fine size is larger, hence a smaller mesh size, the mixture will go to heater 18. For example, in embodiments where the silica source has a silica fine size of about 100 mesh or less, system 10 may use heater 18. In embodiments where the silica fine size is about 100 mesh or greater, system 10 may use heater 16.

In one embodiment of the present invention, system 10 may be automated to produce continuous quantities of metasilicate compound. In an embodiment, system 10 may include sieve 28 to separate particles depending on the particle's silica fine size. Although FIG. 1 shows sieve 28 as part of heater 14, sieve 28 may be placed apart from heater 14. Sieve 28 may allow for finer silica particles to be heated by heater 16 while letting coarser silica particles to be heated by heater 18.

In certain exemplary embodiments of the present invention, system 10 has at least one duct 26 to direct a portion of the heat from heater 18 to heater 14. In other exemplary embodiments, system 10 has at least one duct 24 to direct a portion of the heat from heater 16 to heater 14. Ducts 24 and 26 may allow for more efficient use of energy in system 10 by using excess or residual heat from heaters 18 and 16 to help and/or heat heater 14.

In embodiments of the present invention, system 10 may further comprise hammer mill 20. Hammer mill 20 may serve to reduce the size of the metasilicate compound produced by system 10. In embodiments of the present invention, hammer mill 20 may also be a grinder or the like.

In other embodiments of the present invention, system 10 may comprise sprayer 22. Although the illustrated embodiment shows sprayer 22 following hammer mill 20, sprayer 22 may be located before hammer mill 20. Sprayer 22 may serve to add water to the metasilicate compound produced by system 10.

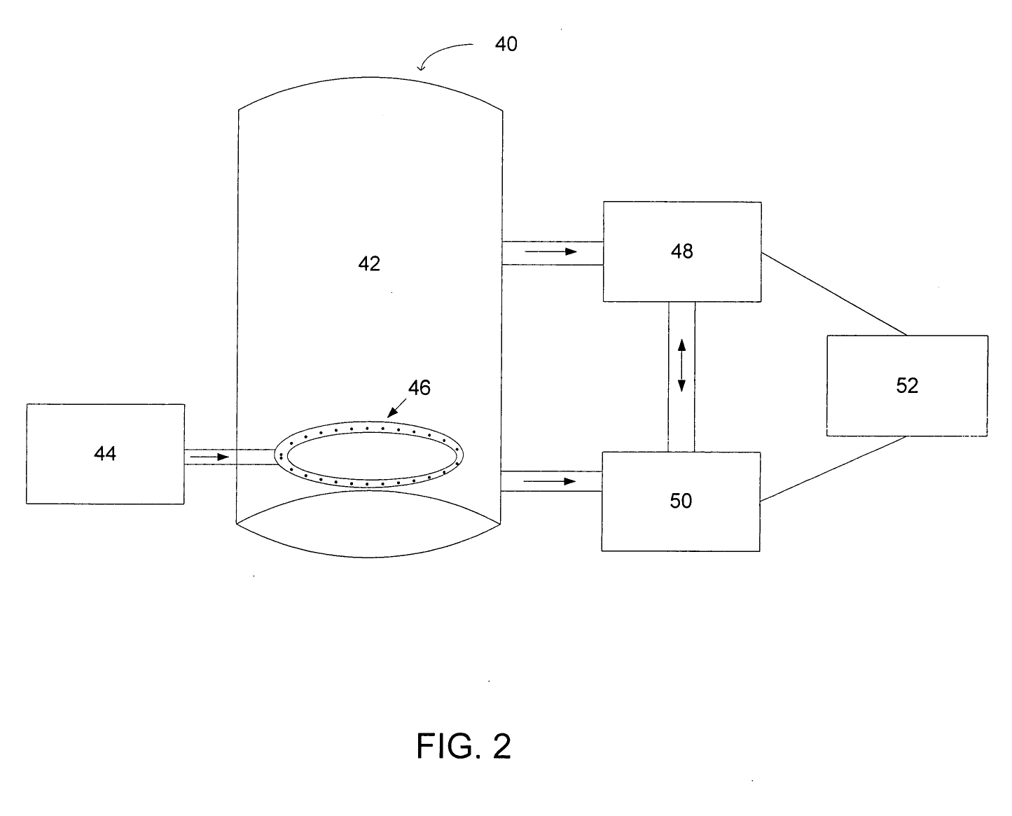

FIG. 2 illustrates system 40 of making a metasilicate compound. System 40 includes tank 42. Tank 42 is operable to receive a silica source and a sodium source. In certain exemplary embodiments, tank 42 may be an autoclave or the like. In other exemplary embodiments, tank 42 may be a cylindrical pressure reactor. In some embodiments of the present invention, the silica source may include silicon dioxide (SiO₂). In other embodiments, the sodium source may include caustic soda (NaOH). In further embodiments, the silica source may include soda ash (Na₂CO₃).

Tank 42 serves to allow the sodium source and silica source to be treated with steam and preferably agitate the same. In the illustrated embodiment in FIG. 2, boiler 44 provides tank 42 with a steam source. Tank 42 may have steam ring 46 disposed proximate to the bottom of tank 42 to steam the sodium source and silica source (and preferably agitate the same), to form a liquid metasilicate mixture with a substantially uniform SiO₂:Na₂O ratio throughout. In certain exemplary embodiments of the present invention, the SiO₂:Na₂O ratio has a ratio of about 0.5 to about 1.2 SiO₂ to about 1 Na₂O. In other embodiments, the SiO₂:Na₂O ratio has a ratio of about 0.7 to about 1.2 SiO₂ to about 1 Na₂O.

In some embodiments of the present invention, system 40 may further comprise vessel 50. Vessel 50 may serve to help solidify and/or crystallize the liquid metasilicate into a more solid form; for example, it may produce solid metasilicate penta hydrate. In certain exemplary embodiments, the liquid metasilicate may be seeded to encourage a transformation, e.g. a crystallization.

In other embodiments of the present invention, oven 48 may be associated with vessel 50 or tank 42. Oven 48 may serve to reduce the water content of the liquid metasilicate compound or crystallized and/or solid metasilicate compound. Following the teachings of the present invention, one may adjust the water content of the metasilicate compound depending on the desired end detergent product.

System 40, in certain embodiments, may further comprise hammer mill 52. Hammer mill 52 may be associated with vessel 50 and/or oven 48. Hammer mill 52 may serve the same function as hammer mill 20 in system 10 described above and not repeated here.

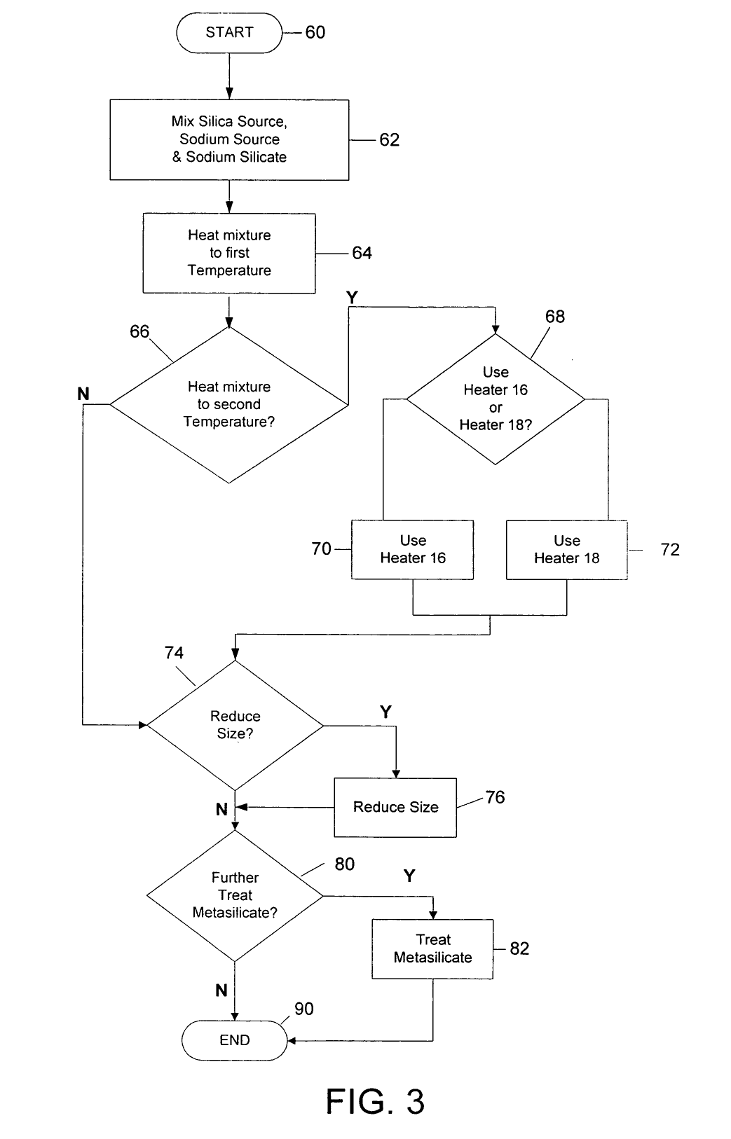

FIG. 3 illustrates a method of making metasilicate according to embodiments of the present invention. The method starts at step 60. The method then proceeds to step 62 where a sodium source, a silica source, and sodium silicate are mixed. Mixer 12 may be used for this purpose, which in some embodiments may be a finger mixer or a ribbon mixer or the like to achieve the desired purpose. This step preferably forms a mixture with a substantially uniform SiO₂:Na₂O ratio throughout.

Once the mixture is formed, the method proceeds to step 64, where the mixture is heated to a first temperature. In certain embodiments, the first temperature may be in the range of about 400° C. to about 700° C. At step 64, it is believed a pre-decomposition of the sodium source and silica source may occur. In other embodiments, the sodium source, silica source, and sodium silicate may react to form metasilicate compound.

At step 66, the mixture may be heated to a second temperature. If the mixture is not heated to a second temperature, then the method proceeds to step 74. If the mixture is heated to a second temperature, then the method proceeds to step 68.

At step 68, the mixture may proceed to heater 16 or heater 18 depending upon the circumstances. One factor to be considered at step 68 is the fine size of the silica source. It has been discovered that it is preferred to send a mixture with a silica fine size from about 40 to about 100 mesh (100 mesh or less) to heater 18. And it has been discovered that it is preferable to send a mixture with a silica fine size from about 100 to about 180 mesh (100 mesh or greater) to heater 16. If the mixture is heated in heater 16, the method proceeds to step 70. At step 70, heater 16 heats the mixture to a second temperature. In some embodiments, the second temperature may range from about 700° C. to about 900° C. It is believed that due to this heating step, the mixture more fully reacts to produce a desirable metasilicate compound.

At step 68, if the mixture is heated by heater 18, the method proceeds to step 72. At step 72, heater 18 heats the mixture. In one embodiment, heater 18 heats the mixture to a temperature in the range of about 950° C. to about 1500° C.

In embodiments where the method allows input of silica of varying silica fine size, such as automated applications, sieve 28 may separate the mixture into two separate mixtures. Then the method would use both steps 70 and 72.

Preferably, after the mixture has been heated to a second temperature, either through use of heater 16 or heater 18, or in a process that uses both heater 16 and heater 18, and the method proceeds to step 74.

At step 74, the individual particles of the metasilicate compound may be reduced in size. The size of the particles of metasilicate may be reduced so that an end detergent or cleaner has a certain desired characteristic. If it is not desired to reduce the particle size of the metasilicate, the method proceeds to step 80. If it is desired to reduce the size of the individual particles of metasilicate, the method proceeds to step 76 where hammer mill 20 may reduce the individual particle size of the metasilicate. Once the metasilicate particle size has been reduced to a size desired, the method proceeds to step 80.

At step 80, the metasilicate may be further treated or for example, hydrated. Because the current method uses heat, the metasilicate compound may be relatively anhydrous. It may be desirable that the metasilicate compound have a desired level of hydration so that the metasilicate compound has a desired bulk or melting temperature. If the metasilicate compound is not hydrated or further treated, the method proceeds to step 90 where the metasilicate compound is ready for use. If the metasilicate compound is further treated, the method proceeds to step 82 where, in an embodiment, sprayer 22 hydrates the metasilicate compound to a desired level. After the metasilicate compound has been hydrated, the method proceeds to step 90 where the metasilicate compound is ready for use.

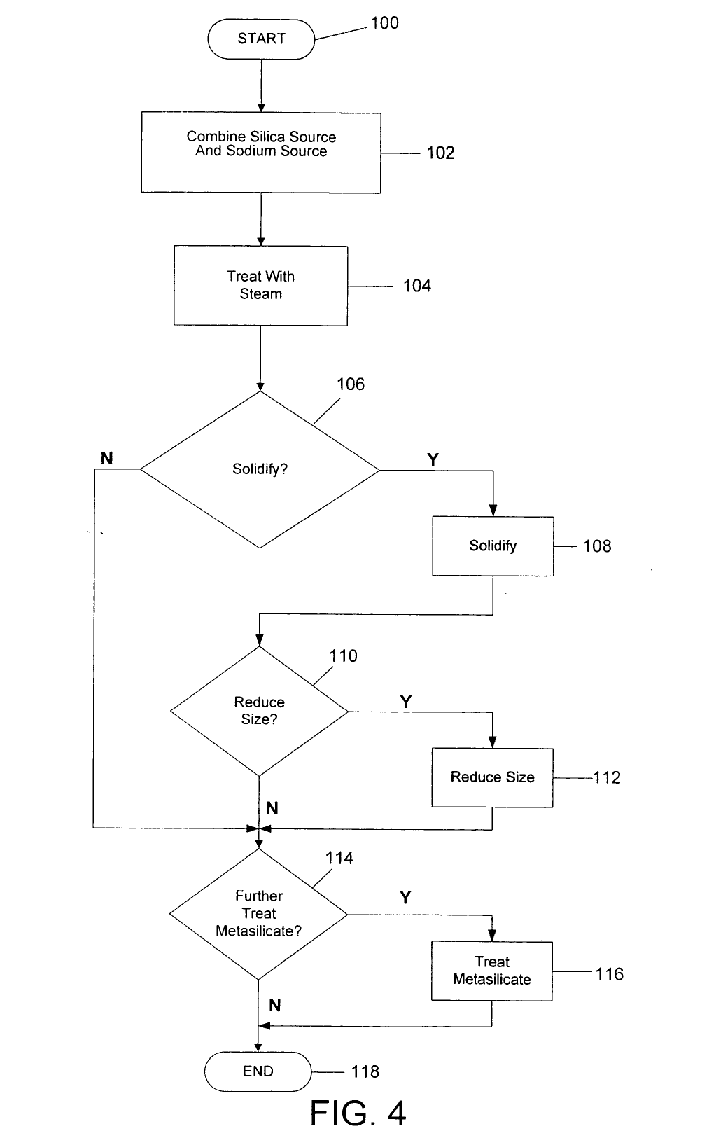

FIG. 4 illustrates a flow chart for another method of making metasilicate according to embodiments of the present invention. The method starts at step 100. The method then proceeds to step 102 where a silica source and a sodium source are combined. In an embodiment, the silica source and sodium source are combined in tank 42. Once the silica source and the sodium source are combined, the method proceeds to step 104.

At step 104 the silica source and sodium source are treated with steam, preferably agitating the same. Steam may be provided by boiler 44 and distributed to tank 42 through steam ring 46. At step 104, liquid metasilicate compound may be produced. In certain embodiments, the metasilicate has a SiO₂:Na₂O ratio of about 0.5 to about 1.2 SiO₂ to about 1 Na₂O. In another embodiment of the present invention, the metasilicate has a ratio of about 0.7 to about 1.2 SiO₂ to about 1 Na₂O.

Once the liquid metasilicate compound has been produced, the method proceeds to step 106. At step 106, the liquid metasilicate may be transformed into a solid form, e.g., crystallized. If the liquid metasilicate is not transformed, the method proceeds to step 114. If it is desirable to solidify or crystallize the metasilicate, the method proceeds to step 108.

At step 108, the liquid metasilicate compound may enter vessel 50. Vessel 50 allows the liquid metasilicate compound to solidify or crystallize. In certain embodiments, seed may be added to the liquid metasilicate compound in order to encourage solidification. After step 108, a solid metasilicate compound is produced. In certain embodiments of the present invention, the solid metasilicate compound is metasilicate penta hydrate. Once a solid metasilicate is produced, the method proceeds to step 110.

At step 110, the size of the individual particle size of the metasilicate may be reduced if desired. If it is not desired to reduce the size of the individual particles of metasilicate, the method proceeds to step 114. If it is desirable to reduce the size of the individual particles of the metasilicate, the method proceeds to step 112 where hammer mill 52 may reduce the individual particle size of the metasilicate. Once the metasilicate has been reduced to a desired size, the method proceeds to step 114.

At step 114, the solid or liquid metasilicate compound may be further treated, for example, to remove water. Because the reaction may occur with steam, the metasilicate compound produced is relatively hydrated. However, it may be desirable to have a metasilicate compound with a particular water content. If the metasilicate compound is not treated to remove water, the method proceeds to step 118 where the metasilicate compound is ready for use. If the metasilicate compound is to be treated to remove water, oven 48 or the like may be used to remove water content from the metasilicate compound. Once the metasilicate has a desired water content, the method proceeds to step 118 where the metasilicate compound is ready for use.

According to an embodiment of the present invention, a detergent composition includes a cleaning agent and a metasilicate compound having the formula X(SiO₂).(Na₂O).Z(H₂O), where X is about 0.5 to about 1.2, and where Z is greater than about 0.1. In an embodiment, the detergent composition includes, by weight, about 1% to about 45% cleaning agent; and about 3% to about 95% the metasilicate compound.

The cleaning agents of the present invention include surfactants. Suitable surfactants may include anionic surfactants, cationic surfactants, nonionic surfactants, amphoteric surfactants, and mixtures thereof. The anionic surfactant may include selected from alkylbenzene sulfonate, alkyl sulfate, alkyl ethoxy ether sulfate, and mixtures thereof. A preferred surfactant includes linear alkylbenzene sulfonate. In embodiments of the present invention, the cleaning agent may also comprise soda ash. In certain embodiments, the cleaning agent, for example the surfactant, may form a salt with the soda ash, for example a sodium salt linear alkylbenzene sulfonate. In other embodiments, potassium and/or ammonium may be used to form a salt with the cleaning agent.

The detergent compositions of the present invention may also include the following additives. Additives, for the purpose of this disclosure, include, but are not limited to, supplemental builders, chelating agents, dispersing agents, soil release agents, enzymes, bleaching agents (including photobleaches and borates such as sodium perborate), fabric softening clays, dye transfer inhibiting ingredients, fillers, optical brightners, water, solvents, alkaline agents, conditioners, corrosion protectors, bluing agents, caking preventatives, antioxidants, citrates, redeposition agents, dyes, pigments, germicides, perfumes, polyethylene glycols, glycerines, sodium hydroxides, alkylbenzenes, fatty alcohols, and combinations thereof. One skilled in the art, with the benefit of this disclosure will recognize appropriate additives desired for a detergent application.

The supplemental builders may include phosphate-containing detergent builders; inorganic non-phosphate builders, including alkali metal silicates, carbonates, citrates, and aluminosilicates; and other organic builders.

The supplemental fillers may include sodium sulfate, calcium carbonate, talc and hydrated magnesium silicate-containing minerals.

In an example embodiment of the present invention, a detergent composition includes, by weight, about 13% to about 15% a cleaning agent; about 25% to 30% a metasilicate compound having the formula X(SiO₂).(Na₂O).Z(H₂O), where X is about 0.5 to about 1.2, and where Z is greater than about 0.1; about 45% to about 50% a filler; and about 10% at least one additive. In an embodiment, the filler material is sodium sulfate.

In another example embodiment of the present invention, a detergent composition includes, by weight, A detergent composition comprising, by weight, about 15% to about 17% a cleaning agent; about 30% to about 40% a metasilicate compound having the formula: X(SiO₂).(Na₂O).Z(H₂O), where X is about 0.5 to about 1.2, and where Z is greater than about 0.1; about 45% to about 50% a filler; and about 3% to about 6% at least one additive.

In an example embodiment of the present invention, a detergent composition includes, by weight, about 15% to about 18% a cleaning agent; about 24% to about 38% a metasilicate compound having the formula: X(SiO₂).(Na₂O).Z(H₂O) where X is about 0.5 to about 1.2, and where Z is greater than about 0.1; about 35% to about 40% a filler; and about 10% to about 12% at least one additive.

In another example embodiment of the present invention, a detergent composition includes, by weight, about 15.5% to about 18% a cleaning agent; about 35.5% to about 41.5% a metasilicate compound having the formula: X(SiO₂).(Na₂O).Z(H₂O), where X is about 0.5 to about 1.2, and where Z is greater than about 0.1; about 37.5% to about 43.5% a filler; and about 4% to about 6% at least one additive.

In certain exemplary embodiments of the present invention, a detergent composition includes, by weight, about 13% to about 15% a cleaning agent; about 29% to about 35% a metasilicate compound having the formula: X(SiO₂).(Na₂O).Z(H₂O), where X is about 0.5 to about 1.2, and where Z is greater than about 0.1; about 48% to about 54% a filler; and about 2% to about 4% at least one additive.

In other exemplary embodiments of the present invention, a detergent composition includes, by weight, about 13.5% to about 15% a cleaning agent; about 30% to about 34.5% a metasilicate compound having the formula: X(SiO₂).(Na₂O).Z(H₂O), where X is about 0.5 to about 1.2, and where Z is greater than about 0.1; about 48.5% to about 54% a filler; and about 2% to about 3% at least one additive.

In another embodiment of the present invention, a detergent composition includes, by weight, about 20% to about 22% a cleaning agent; about 24% to about 25% a metasilicate compound having the formula: X(SiO₂).(Na₂O).Z(H₂O), where X is about 0.5 to about 1.2, and where Z is greater than about 0.1; and about 50% to about 55% a filler. In a further embodiment, the detergent composition may further include at least one additive.

To facilitate a better understanding of the present invention, the following examples of preferred embodiments are given. In no way should the following examples be read to limit or define the scope of the invention—they are intended as examples only.

### EXAMPLES

### Example I

1.7 parts of soda ash (Na₂CO₃) and one part of sand (SiO₂) were blended in a mixer using a sodium silicate X(SiO₂).Y(Na₂O) solution where the ratio of X/Y is 2.35 and it has a strength of 2.5% solids as a binder; and using hot air (exhaust from smelter) to dry and preheat the mixture. The mixture was fed into a furnace and reacted for about 2 hours at 1100° C. to produce a melted product which was then cooled and ground with a hammer mill to obtain a product with detergent size particles.

### Example II

1.7 parts of soda ash (Na₂CO₃) and one part of sand (SiO₂) with an average fine size (AFS) over 130 mesh were blended in a mixer using a sodium silicate X(SiO₂).Y(Na₂O) solution where the ratio of X/Y is about 2.35 and it has a strength of about 2.5% solids as a binder; and hot air (exhaust from calcinator) was used to dry and preheat the mixture. The mixture was fed into a rotary Kiln at a temperature of approximately 800° C. The product was then cooled and ground with a hammer mill to obtain a product with detergent size particles.

### Example III

2.5 parts of caustic soda (NaOH) was diluted at 50% with water and one part of sand X(SiO₂) were fed into cylindrical pressure reactor (e.g., an autoclave) in which the hydrothermic reaction carried out is designed so that the mixture of sand and caustic soda present can be heated to reaction temperatures of approximately 150° C. to 180° C. Saturated steam was introduced until the desired reaction temperature was reached. The steam was introduced and at the same time some steam was vented in order to have a constant feed of such steam which besides heating the mixture at the same time agitated the mixture to maintain the reaction, this process takes from about 2-4 hours. Product was then cooled and ground with a hammer mill to obtain a product with detergent size particles of metasilicate penta hydrate.

### Example IV

A builder of the present invention was made according to a method of the present invention and was used to prepare a detergent product using a standard spray-drying process for making detergent base granules. A slurry was prepared by mixing together the following liquid and solid ingredients in the following order: 17 parts sodium salt linear alkylbenzene sulfonate (NaLAS) diluted in water at about 40% solids; about 27 parts of a solid product X(SiO₂).Y(Na₂O).Z(H₂O), where the ratio of X to Y was about 1.1 and where Z has a value of 5; and about 45 parts sodium sulfate. The mixture was processed in a spray-drying tower with a co-current stream of hot drying air at about 225° C. inlet temperatures and about 100° C. drying air temperature at the outlet stream. The final product had a moisture content of about 5% determined at about 125° C.

### Example V

A neutralizing agent of the present invention was made according to the process of the present invention and was used to prepare a detergent product using a standard spray-drying process for making detergent base granules. A mix slurry was prepared by mixing together the following liquid and solid ingredients in the following order: about 17 parts sodium salt linear alkylbenzene sulfonate (NaLAS) diluted in water at about 40% solids; approximately 27 parts of a solid product X(SiO₂).Y(Na₂O).Z(H₂O); where the ratio of X to Y was about 1.1 and where Z has a value of 5, and about 45 parts sodium sulfate. The mixture was processed in a spray-drying tower with a co-current stream of hot drying air at about 225° C. inlet temperatures and about 100° C. drying air temperature at the outlet stream. The final product had a moisture content of about 5% determined at approximately 125° C.

### Example VI

In this example, the metasilicate partially substitutes for sodium tripolyphosphate (STPP) in a conventional detergent composition. A slurry containing partial metasilicate builder substitution was prepared as follows:

A slurry was prepared by mixing together the following liquid and solid ingredients in the following order: about 17 parts linear sodium alkylbenzene sulfonate (NaLAS) diluted in water at about 40% solids; about 10 parts of a solid product STPP (sodium tripolyphosphate); about 17 parts a solid product X(SiO₂).Y(Na₂O).Z(H₂O), where the ratio of X to Y was about 1.1 and wherein Z has a value of 5; and 45 parts sodium sulfate. The mixture was processed in a spray-drying tower with a co-current stream of hot drying air at about 225° C. inlet temperatures and about 100° C. drying air temperature at the outlet stream. The final product had a moisture content of about 5% determined at about 125° C.

### Example VII

A metasilicate compound of the present invention was made according to a method of the present invention and compared to the calcium exchange capacity of sodium tripolyphosphate (STPP). The comparison was performed by reacting a preslurried sample with an excess of Ca⁺² and titrating the excess by reacting with standard EDTA (ethylene diaminetetracetic acid disodium salt) using eriochrome black T as indicator and maintaining pH control at 10 with a buffer solution of NH₄C₁ and NH₄OH. The results showed a similar performance between the metasilicate compound and the STPP. The metasilicate compound had a capacity of 259 mgCaCO₃/gram versus 262 mgCaCO₃/gram STPP.

Therefore, the present invention is well adapted to attain the ends and advantages mentioned as well as those that are inherent therein. While numerous changes may be made by those skilled in the art, such changes are encompassed within the spirit of this invention as defined by the appended claims.

What is claimed is:

1. A method for making a metasilicate compound for use in detergent compositions comprising:
mixing a sodium source, a silica source and sodium silicate to form a mixture having a substantially uniform SiO₂:Na₂O ratio throughout;
heating the mixture to a temperature of about 400° C. to about 700° C.; and
wherein if the mixture has a silica source fine size of about 100 mesh or greater, further heating the mixture to a temperature of about 700° C. to about 900° C., or
if the mixture has a silica source fine size less than about 100 mesh, further heating the mixture to a temperature of about 950° C. to about 1500° C. to form the metasilicate compound.

2. A method of making a metasilicate compound for use in detergent compositions comprising:
mixing a sodium source, a silica source and sodium silicate to form a mixture with a substantially uniform SiO₂:Na₂O ratio throughout; and
heating the mixture to first and second temperatures to form the metasilicate compound.

3. The method of claim 2 further comprising reducing the size of individual particles of the metasilicate compound.

4. The method of claim 2 further comprising hydrating the metasilicate compound.

5. The method of claim 2 wherein the first temperature is in the range of about 400° C. to about 700° C.

6. The method of claim 2 wherein the second temperature is in the range of about 400° C. to about 1500° C.

7. The method of claim 2 wherein the first temperature is in the range of about 400° C. to about 700° C. and the second temperature is in the range of about 700° C. to about 1500° C.

8. The method of claim 2 wherein heating the mixture to a second temperature comprises heating the mixture to a temperature of about 700° C. to about 900° C. when the silica source comprises a fine size of about 100 mesh or greater.

9. The method of claim 2 wherein heating the mixture to a second temperature comprises heating the mixture to a temperature of about 950° C. to about 1500° C. when the silica source comprises a fine size of about 100 mesh or less.

10. The method of claim 2 wherein the sodium source comprises soda ash (Na₂CO₃).

11. The method of claim 2 wherein the sodium source comprises caustic soda (NaOH).

12. The method of claim 2 wherein the silica source comprises silicon oxide.

13. The method of claim 2 wherein the SiO₂:Na₂O ratio comprises a ratio of about 0.5 to about 1.2 SiO₂ to about 1 Na₂O.

14. The method of claim 2 wherein the SiO₂:Na₂O ratio comprises a ratio of about 0.9 to about 1.1 SiO₂ to about 1 Na₂O.

15. A method of making a metasilicate compound for use in detergent compositions comprising:
combining a silica source and a sodium source; and
treating the silica source and the sodium source with steam to form a liquid metasilicate compound.

16. The method of claim 15 further comprising solidifying or crystallizing the liquid metasilicate compound to form a solid metasilicate compound.

17. The method of claim 16 wherein crystallizing the liquid metasilicate compound includes seeding the liquid metasilicate compound.

18. The method of claim 16 wherein the solid metasilicate compound comprises metasilicate penta hydrate.

19. The method of claim 16 further comprising reducing the individual particle size of the solid metasilicate compound.

20. The method of claim 16 further comprising removing water from the solid metasilicate compound.

21. The method of claim 15 further comprising removing water from the liquid metasilicate compound.

22. The method of claim 15 wherein the sodium source comprises soda ash (Na₂CO₃).

23. The method of claim 15 wherein the sodium source comprises caustic soda (NaOH).

24. The method of claim 15 wherein the silica source comprises silicon oxide.

25. The method of claim 15 wherein the metasilicate compound comprises a SiO₂:Na₂O ratio of about 0.5 to about 1.2 SiO₂ to about 1 Na₂O.

26. The method of claim 15 wherein the metasilicate compound comprises a SiO₂:Na₂O ratio of about 0.9 to about 1.1 SiO₂ to about 1 Na₂O.

27. A system for making a metasilicate compound comprising:
a mixer to receive, mix, and agglomerate a sodium source, a silica source and sodium silicate into a first mixture with a substantially uniform SiO₂:Na₂O ratio throughout;
a first heater to heat the first mixture to a first temperature of about 400° C. to about 700° C.;
a second heater to heat the mixture to a second temperature of about 700° C. to about 900° C. if the mixture has a silica fine size of about 100 mesh or greater; or
a second heater to heat the mixture to a temperature of about 950° C. to about 1500° C. if the mixture has a silica fine size of less than 100 mesh.

28. A system for making a metasilicate compound comprising:
a mixer to mix a sodium source, a silica source and sodium silicate into a mixture with a substantially uniform SiO₂:Na₂O ratio throughout; and
a heater to heat the mixture to a first temperature of about 400° C. to about 700° C.

29. The system of claim 28 further comprising a second heater to heat the mixture to a second temperature.

30. The system of claim 29 further comprising at least one duct to direct at least a portion of heat from the second heater to the first heater.

31. The system of claim 29 wherein the second temperature is about 700° C. to about 900° C. and the silica source has a silica fine size of 100 mesh or greater.

32. The system of claim 29 wherein the second temperature is about 950° C. to about 1500° C. and the silica source has a silica fine size of less than about 100 mesh.

33. The system of claim 28 further comprising a hammer mill to reduce the size of the individual particles of the metasilicate.

34. The system of claim 28 further comprising a sprayer to spray the metasilicate compound with water.

35. The system of claim 28 wherein the mixer comprises a finger mixer.

36. The system of claim 28 wherein the mixer comprises a ribbon mixer.

37. The system of claim 28 wherein the sodium source comprises soda ash (Na₂CO₃).

38. The system of claim 28 wherein the sodium source comprises caustic soda (NaOH).

39. The system of claim 28 wherein the silica source comprises silicon dioxide.

40. The system of claim 28 wherein the SiO₂:Na₂O ratio comprises a ratio of about 0.7 to about 1.2 SiO₂ to about 1 Na₂O.

41. A system for making a liquid metasilicate compound comprising:
a tank to receive and steam agitate a sodium source and a silica source to form a liquid mixture having a substantially uniform SiO₂:Na₂O ratio throughout.

42. The system of claim 41 further comprising a vessel to allow the liquid mixture to form a solid metasilicate compound.

43. The system of claim 42 further comprising a hammer mill to reduce the size of the individual particles of the solid metasilicate compound.

44. The system of claim 42 further comprising an oven to remove water from the solid metasilicate compound.

45. The system of claim 41 further comprising an oven to remove water from the liquid mixture.

46. The system of claim 41 comprising a boiler to provide steam to the tank.

47. The system of claim 41 wherein the sodium source comprises soda ash (Na₂CO₃).

48. The system of claim 41 wherein the sodium source comprises caustic soda (NaOH).

49. The system of claim 41 wherein the silica source comprises silicon oxide.

50. The system of claim 41 wherein the SiO₂:Na₂O ratio comprises a ratio of about 0.5 to about 1.2 SiO₂ to about 1 Na₂O.

51. The system of claim 41 wherein the SiO₂:Na₂O ratio comprises a ratio of about 0.7 to about 1.2 SiO₂ to about 1 Na₂O.

52. A compound for use in a detergent composition comprising the formula:
X(SiO₂).(Na₂O).Z(H₂O)
wherein X comprises about 0.5 to about 1.2; and
wherein Z comprises greater than about 0.1.

53. The compound of claim 52 wherein X comprises about 0.9 to about 1.1.

54. The compound of claim 52 wherein Z comprises about 5.

55. The compound of claim 52 wherein Z comprises about 0.1 to about 5.

56. The compound of claim 52 wherein X(SiO₂).(Na₂O).Z(H₂O) comprises a liquid form.

57. The compound of claim 52 wherein Z comprises about 9 or higher.

58. The compound of claim 52 wherein X(SiO₂).(Na₂O).Z(H₂O) comprises a solid form.

59. The compound of claim 52 wherein Z comprises about 0.1 to about 9.

60. A detergent composition comprising:
a cleaning agent; and
an effective amount of builder, the builder having the formula:
X(SiO₂).(Na₂O).Z(H₂O)
wherein X comprises about 0.5 to about 1.2; and
wherein Z comprises greater than about 0.1.

61. The detergent composition of claim 60 wherein Z comprises about 5.

62. The detergent composition of claim 60 further comprising at least one additive, wherein the additive is selected from the group consisting of a supplemental builder, a chelating agent, a dispersing agent, a soil release agent, an enzyme, a bleaching agent, a fabric softening clay, a dye transfer inhibiting ingredient, a filler, an optical brightner, water, a solvent, an alkaline agent, a conditioner, a corrosion protector, a bluing agent, a caking preventative, an antioxidant, a citrate, a redeposition agent, a dye, a pigment, a germicide, a perfume, a polyethylene glycol, a glycerine, a sodium hydroxide, an alkylbenzene, a fatty alcohol, and combinations thereof.

63. A detergent composition comprising:
a cleaning agent; and
an effective amount of neutralizing agent to neutralize the cleaning agent, the neutralizing agent having the formula:
X(SiO₂).(Na₂O).Z(H₂O)
wherein X comprises about 0.5 to about 1.2; and
wherein Z comprises greater than about 0.1.

64. The detergent composition of claim 63 wherein Z comprises 5.

65. The detergent composition of claim 63 further comprising at least one additive, wherein the additive is selected from the group consisting of a supplemental builder, a chelating agent, a dispersing agent, a soil release agent, an enzyme, a bleaching agent, a fabric softening clay, a dye transfer inhibiting ingredient, a filler, an optical brightner, water, a solvent, an alkaline agent, a conditioner, a corrosion protector, a bluing agent, a caking preventative, an antioxidant, a citrate, a redeposition agent, a dye, a pigment, a germicide, a perfume, a polyethylene glycol, a glycerine, a sodium hydroxide, an alkylbenzene, a fatty alcohol, and combinations thereof.

66. The metasilicate compound produced by the system of claim 41.

67. The metasilicate compound produced by the system of claim 28.

68. The metasilicate compound produced by the system of claim 27.

69. The metasilicate compound produced by the method of claim 15.

70. The metasilicate compound produced by the method of claim 2.

71. The metasilicate compound produced by the method of claim 1.

72. A detergent composition comprising, by weight:
about 1% to about 45% cleaning agent; and
about 3% to about 95% a metasilicate compound having the formula:
X(SiO₂).(Na₂O). Z(H₂O)
wherein X comprises about 0.5 to about 1.2; and
wherein Z comprises greater than about 0.1.

73. The detergent composition of claim 72 wherein the cleaning agent comprises a surfactant.

74. The detergent composition of claim 72 further comprising at least one additive, wherein the additive is selected from the group consisting of a supplemental builder, a chelating agent, a dispersing agent, a soil release agent, an enzyme, a bleaching agent, a fabric softening clay, a dye transfer inhibiting ingredient, a filler, an optical brightner, water, a solvent, an alkaline agent, a conditioner, a corrosion protector, a bluing agent, a caking preventative, an antioxidant, a citrate, a redeposition agent, a dye, a pigment, a germicide, a perfume, a polyethylene glycol, a glycerine, a sodium hydroxide, an alkylbenzene, a fatty alcohol, and combinations thereof.

75. A detergent composition comprising, by weight:
about 13% to about 15% a cleaning agent;
about 25% to about 30% a metasilicate compound having the formula:
X(SiO₂).(Na₂O).Z(H₂O)
wherein X comprises about 0.5 to about 1.2, and
wherein Z comprises greater than about 0.1;
about 45% to about 50% a filler; and
about 10% at least one additive.

76. The detergent composition of claim 75 wherein the cleaning agent comprises a linear alkyl sulfonate.

77. The detergent composition of claim 75 wherein the filler comprises sodium sulfate.

78. The detergent composition of claim 75 wherein the at least one additive is selected from the group consisting of a supplemental builder, a chelating agent, a dispersing agent, a soil release agent, an enzyme, a bleaching agent, a fabric softening clay, a dye transfer inhibiting ingredient, a filler, an optical brightner, water, a solvent, an alkaline agent, a conditioner, a corrosion protector, a bluing agent, a caking preventative, an antioxidant, a citrate, a redeposition agent, a dye, a pigment, a germicide, a perfume, a polyethylene glycol, a glycerine, a sodium hydroxide, an alkylbenzene, a fatty alcohol, and combinations thereof.

79. A detergent composition comprising, by weight:
about 15% to about 17% a cleaning agent;
about 30% to about 40% a metasilicate compound having the formula:
X(SiO₂).(Na₂O).Z(H₂O)
wherein X comprises about 0.5 to about 1.2, and
wherein Z comprises greater than about 0.1;
about 45% to about 50% a filler; and
about 3% to about 6% at least one additive.

80. The detergent composition of claim 79 wherein the cleaning agent comprises a linear alkyl sulfonate.

81. The detergent composition of claim 79 wherein the filler comprises sodium sulfate.

82. The detergent composition of claim 79 wherein the at least one additive is selected from the group consisting of a supplemental builder, a chelating agent, a dispersing agent, a soil release agent, an enzyme, a bleaching agent, a fabric softening clay, a dye transfer inhibiting ingredient, a filler, an optical brightner, water, a solvent, an alkaline agent, a conditioner, a corrosion protector, a bluing agent, a caking preventative, an antioxidant, a citrate, a redeposition agent, a dye, a pigment, a germicide, a perfume, a polyethylene glycol, a glycerine, a sodium hydroxide, an alkylbenzene, a fatty alcohol, and combinations thereof.

83. A detergent composition comprising, by weight:
about 15% to about 18% a cleaning agent;
about 24% to about 38% a metasilicate compound having the formula:
X(SiO₂).(Na₂O).Z(H₂O)
wherein X comprises about 0.5 to about 1.2, and
wherein Z comprises greater than about 0.1;
about 35% to about 40% a filler; and
about 10% to about 12% at least one additive.

84. A detergent composition comprising, by weight:
about 15.5% to about 18% a cleaning agent;
about 35.5% to about 41.5% a metasilicate compound having the formula:
X(SiO₂).(Na₂O).Z(H₂O)
wherein X comprises about 0.5 to about 1.2, and
wherein Z comprises greater than about 0.1;
about 37.5% to about 43.5% a filler; and
about 4% to about 6% at least one additive.

85. A detergent composition comprising, by weight:
about 13% to about 15% a cleaning agent;
about 29% to about 35% a metasilicate compound having the formula:
X(SiO₂).(Na₂O).Z(H₂O)
wherein X comprises about 0.5 to about 1.2, and
wherein Z comprises greater than about 0.1;
about 48% to about 54% a filler; and
about 2% to about 4% at least one additive.

86. A detergent composition comprising, by weight:
about 13.5% to about 15% a cleaning agent;
about 30% to about 34.5% a metasilicate compound having the formula:
X(SiO₂).(Na₂O).Z(H₂O)
wherein X comprises about 0.5 to about 1.2, and
wherein Z comprises greater than about 0.1;
about 48.5% to about 54% a filler; and
about 2% to about 3% at least one additive.

87. A detergent composition comprising, by weight:
about 20% to about 22% a cleaning agent;
about 24% to about 25% a metasilicate compound having the formula:
X(SiO₂).(Na₂O).Z(H₂O)
wherein X comprises about 0.5 to about 1.2, and
wherein Z comprises greater than about 0.1; and
about 50% to about 55% a filler.

88. The composition of claim 87 further comprising at least one additive.
